(19) United States
(12) Patent Application Publication
(10) Pub. No.: US 2010/0127990 A1
(43) Pub. Date: May 27, 2010

(54) APPARATUS AND METHOD FOR KEYPAD OF PORTABLE TERMINAL

(75) Inventors: Jin SAGONG, Daegu (KR); Hark-Sang KIM, Daegu (KR); Sang-Ryul PARK, Gumi-si (KR)

Correspondence Address: Jefferson IP Law, LLP, 1130 Connecticut Ave., NW, Suite 420, Washington, DC, 20036, US

(73) Assignee: Samsung Electronics Co., Ltd, Suwon-si (KR)

(21) Appl. No.: 12/611,535

(22) Filed: Nov. 3, 2009

(30) Foreign Application Priority Data
Nov. 27, 2008 (KR) 10-2008-0119177

(51) Int. Cl. G06F 3/02

(52) U.S. Cl. 345/169

(57) ABSTRACT

An apparatus and method for a keypad of a portable terminal are provided. The keypad apparatus includes a top unit, a bottom unit, and a control unit. The top unit has numerals and characters printed on the top of the keypad. The bottom unit includes a keypad connection unit having a power supply unit, a ground region, a divided connection unit and a common connection unit connected when the numeral or character of the keypad is pressed. The control unit is connected to the divided connection unit and the common connection unit to receive a generated signal according to the press of the numeral or character and perform a corresponding function by mapping to a preset key value.

### PRIORITY

This application claims the benefit under 35 U.S.C. §119(a) of a Korean patent application filed in the Korean Intellectual Property Office on Nov. 27, 2008 and assigned Serial No. 10-2008-0119177, the entire disclosure of which is hereby incorporated by reference.

### BACKGROUND OF THE INVENTION

1. Field of the Invention

The present invention relates to an apparatus and method for a keypad of a portable terminal. More particularly, the present invention relates to an apparatus and method for reducing the number of I/O ports of a keypad in a portable terminal.

2. Description of the Related Art

The term “mobile communication terminal” is a generic name for portable terminals, palm PCs, Personal Digital Assistants (PDAs), Hand-held PCs (HPCs), etc. Generally, the mobile communication terminal is a high-tech communication device that can perform not only wireless communication but also various operations through network access. Moreover, the mobile communication terminal provides access to these services almost everywhere.

FIG. 1 illustrates a conventional keypad structure used in a mobile communication terminal. Referring to FIG. 1, a conventional keypad structure uses a 4×3 keypad. The conventional keypad of the portable terminal is configured to include 20 or more keys, including the 12 keys of the 4×3 keypad and other keys such as a NAVIGATION key, a CALL key, and an END key. Approximately 10 I/O ports, including 4 I/O ports along a column (i.e. KEYSENSE 1-4) and 6 I/O ports along a row (not labeled), are used to detect input from the 20 or more keys. For example, when the “2” key is pressed, its input is detected by the uppermost I/O port on the column and the 2^{nd} I/O port along the row (i.e. KEYSENSE 2). Recently, mobile communication terminals are being provided with a QWERTY keypad, similar to a computer keyboard, for user convenience. A QWERTY keypad is configured to include about 40 keys and thus requires approximately 14 I/O ports including 7 I/O ports along a column and 7 I/O ports along a row.

FIG. 2 is a sectional view of a connection unit of a conventional keypad. Referring to FIG. 2, a dome sheet is used to connect an inner circle 10 and an outer concentric circle 20. When the dome sheet is pressed to establish a connection, a current flows therethrough. On the other hand, when no connection is established, no current flows. In this way, a control unit detects only ON/OFF states. Considering again the example of the “2” key, when the “2” key is pressed, a current flows through the connection unit between the uppermost I/O port on the column and the 2^{nd} I/O port along the row (i.e. KEYSENSE 2) so that the key input is detected.

Recent demands by users require that terminals become more multifunctional while becoming smaller in size. To support such improvements, it is required that even more key functions be provided while the overall size of the mobile communication terminal is reduced. To support the reduction in the size of the mobile communication terminal, it is further required that the internal components be made smaller, including being smaller in chip size. However, it is difficult to support a larger keyboard, which requires additional I/O ports, with a smaller chip size. Accordingly, there is a need to provide an apparatus and method for reducing the number of I/O ports.

### SUMMARY OF THE INVENTION

An aspect of the present invention is to address at least the above-mentioned problems and/or disadvantages and to provide at least the advantages below. Accordingly, an aspect of the present invention is to provide an apparatus and method for reducing the number of I/O ports of a keypad in a portable terminal.

In accordance with an aspect of the present invention, an apparatus for a keypad of a portable terminal is provided. The apparatus includes a top unit including a key, a bottom unit including a keypad connection unit corresponding to the key, the keypad connection unit having a divided connection unit, comprised of a plurality of connection subunits, and a common connection unit that are connected when the key is pressed, and a control unit connected to the keypad connection unit to receive a signal generated according to the press of the key and to perform a corresponding function.

In accordance with another aspect of the present invention, a method for using a keypad of a portable terminal is provided. The method includes pressing a key on the keypad, generating a signal from a keypad connection unit corresponding to the key, the keypad connection unit having a common connection unit and a divided connection unit, comprised of a plurality of connection subunits, according to the press of the key, mapping the generated signal to a preset key value, and performing a function corresponding to a key mapped to the preset key value.

In accordance with yet another aspect of the present invention, a key input apparatus is provided. The apparatus includes a divided connection unit including a plurality of connection subunits, and a common connection unit, wherein the divided connection unit is connected to the common connection unit upon operation of the key input apparatus.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a conventional keypad structure;

FIG. 2 is a sectional view of a connection unit of a conventional keypad;

FIGS. 3A and 3B illustrate divisions of a keypad connection unit according to an exemplary embodiment of the present invention;

FIG. 4 illustrates interconnections between a control unit and a divided connection unit of a keypad connection unit according to an exemplary embodiment of the present invention;

FIG. 5 illustrates the overall interconnections for a divided connection unit of a keypad connection unit according to an exemplary embodiment of the present invention; and

FIG. 6 illustrates the divisions of a keypad connection unit according to an exemplary embodiment of the present invention.

FIG. 7 illustrates an apparatus including a keypad connection unit according to an exemplary embodiment of the present invention.

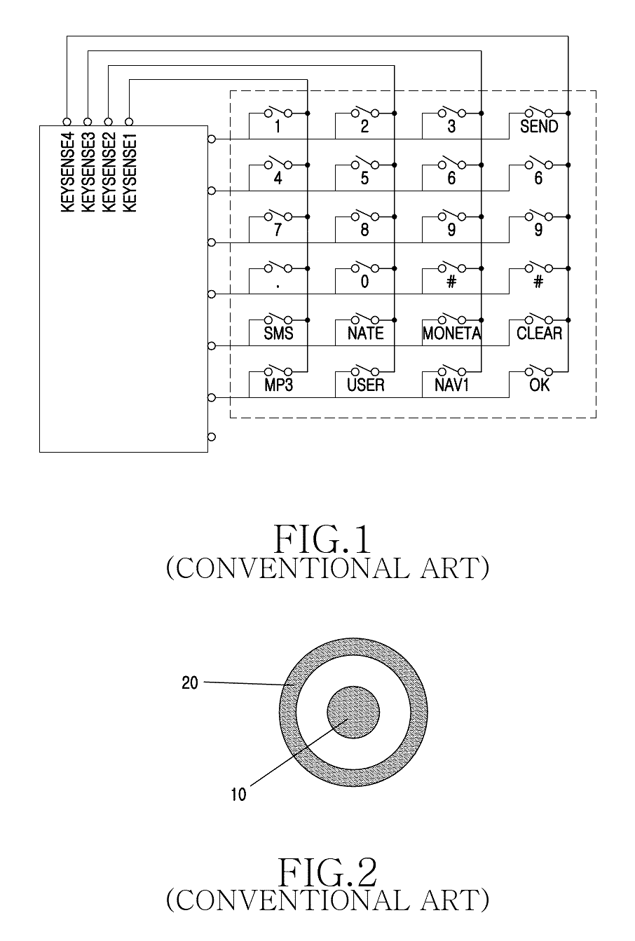

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

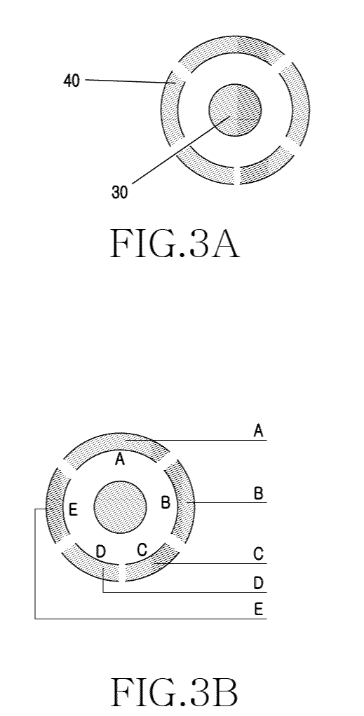

FIGS. 3A and 3B illustrate divisions of a keypad connection unit according to an exemplary embodiment of the present invention.

Referring to FIG. 3A, an outer circle is divided into five equal parts to form five outer regions 40 (i.e., five connection subunits of a divided connection unit). When a dome sheet is pressed, the five outer regions 40 are simultaneously connected to an inner circle 30 (i.e., a common connection unit). The inner circle 30 is connected to a power supply voltage (Vdc) unit (not illustrated). Thus, when the dome sheet is pressed and contact is made between the inner circle 30 and the five outer regions 40, the power supply voltage (Vdc) is applied to each of the five outer regions 40 which, as will be discussed below, supply a signal to a control unit.

Referring to FIG. 3B, interconnections A, B, C, D and E are provided in a Printed Circuit Board (PCB) for connection of the divided connection unit. In the case of hardware connection, all or some of the interconnections A, B, C, D and E are connected to a control unit. A “High” signal input through an interconnection connected to the control unit is detected as “1”, and a “Low” signal input through the interconnection not connected to the control unit is detected as “0”. Thus, a determination can be made as to which key was pressed by mapping the received High and Low signals to a 5-bit digital input value.

Although it has been described that the outer circle is divided into five parts, the number of the divisions may vary depending on the design specifications. That is, the outer circle may be divided into any number of divisions greater than or equal to two.

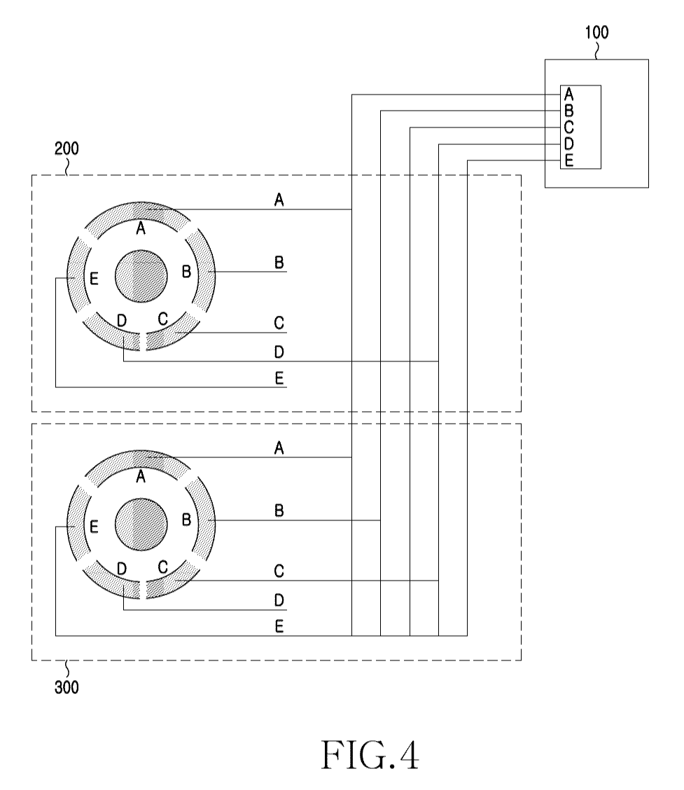

FIG. 4 illustrates a keypad structure of a portable terminal according to an exemplary embodiment of the present invention. As illustrated in FIG. 4, the portable terminal includes a control unit 100 and keypad connection units 200 and 300.

Referring to FIG. 4, when a keypad connection unit is interconnected to a control unit, all or some of the connection subunits A, B, C, D and E of a divided connection unit are connected to corresponding ports of the control unit. In the exemplary embodiment of FIG. 4, when one of the keypad connection units 200 or 300 is connected to the control unit 100, all or some of the five connection subunits A, B, C, D and E of the divided connection unit are connected to corresponding ports of the control unit 100. More specifically, regarding the keypad connection unit 200 in FIG. 4, the connection subunits A, D and E among the connection subunits A, B, C, D and E are connected to corresponding ports of the control unit 100. However, the connection subunits B and C of the keypad connection unit 200 are not connected thereto. Accordingly, when a key corresponding to the keypad connection unit 200 is pressed, signals are generated for all the connection subunits except the non-connected connection subunits B and C and the control unit 100 receives a signal of “10011”. When receiving a signal of “10011”, the control unit 100 detects the press of the specific key by comparing the received signal with a key mapping value stored in a storage unit (not illustrated). For example, if a “10011” value was set to correspond to a number “1”, when the “10011” value is input, a number “1” is displayed or a corresponding function assigned to “1” is performed. For example, a speed dial is executed or a smart phone performs an assigned program.

Regarding keypad connection unit 300 in FIG. 4, the connection subunits A, B, C and E among the connection subunits A, B, C, D and E are interconnected. Accordingly, when a key corresponding to the keypad connection unit 300 is pressed, signals are generated for all the connection subunits except the non-connected connection subunit E and the control unit 100 receives a signal of “11101”. Through the received signal, the control unit 100 detects the press of the specific key. In the above exemplary embodiment, 31 (“00001˜11111”, i.e., 2⁵−1) keys can be implemented through five divisions. That is, the number of keys is 2ⁿ−1 (except “00000”) where “n” is the number of divisions.

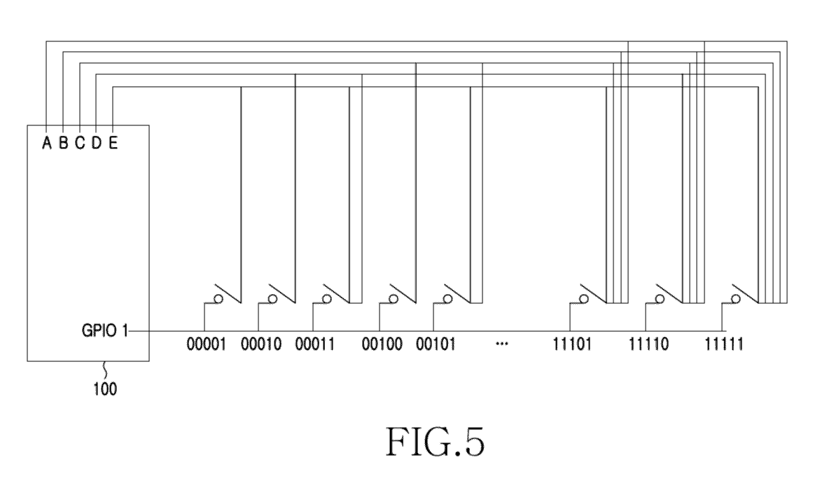

FIG. 5 illustrates the overall interconnections for a divided connection unit of a keypad connection unit according to an exemplary embodiment of the present invention.

Referring to FIG. 5, an exemplary implementation is illustrated wherein each of a plurality of keypad connection units includes five connection subunits which are selectively connected to corresponding ports A, B, C, D and E of a control unit 100. For example, a leftmost keypad connection unit includes a single connection between a connection subunit and I/O port E on the control unit 100. Accordingly, when an input is received on the keypad connection unit, for example by a pressing of the corresponding key by a user, a signal of “00001” is received at the control unit 100. The control unit 100 detects the press of the specific key by comparing the received “00001” signal with a key mapping value stored in a storage unit (not illustrated). Similarly, a keypad connection unit that is located third from the left includes two connections between connection subunits and I/O ports D and E on the control unit 100. Therefore, when an input is received on the keypad connection unit, for example by a pressing of the corresponding key by the user, a signal of “00011” is received at the control unit 100. The control unit 100 detects the press of the specific key by comparing the received “00011” signal with a key mapping value stored in a storage unit (not illustrated). Accordingly, by selectively connecting each of the connection subunits of the keypad connection units to the control unit 100, the control unit 100 is able to discern which of the keypad connection units had been input based on its unique signal. Thus, the control unit 100 is able to reduce the number of I/O ports while supporting additional keys.

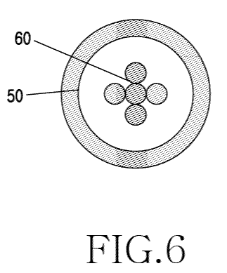

FIG. 6 illustrates the divisions of a keypad connection unit according to an exemplary embodiment of the present invention, in which a divided connection unit is located at the center and a common connection unit is located in the outer region.

Referring to FIG. 6, an inner circle is divided into five equal parts to form five inner circle regions 60 (i.e., five subunits of a divided connection unit). When a dome sheet is pressed, the outer region 50 (i.e., a common connection unit) is simultaneously connected to each of the five inner circle regions 60. The outer region 50 is connected to a power supply voltage (Vdc) unit (not illustrated). Thus, when the dome sheet is pressed and contact is made between the outer region 50 and the five inner circle regions 60, the power supply voltage (Vdc) is applied to each of the five inner circle regions 60 which selectively supply a signal to a control unit depending on connections between the inner circle regions 60 and ports of the control unit. Although 5 inner circle regions 60 are illustrated, this is merely for convenience of explanation and the invention is not so limited. That is, the invention may be embodied having any number of inner circle regions including two or more regions. Furthermore, although not illustrated, it is understood that the inner circle regions 60 are electrically isolated from each other.

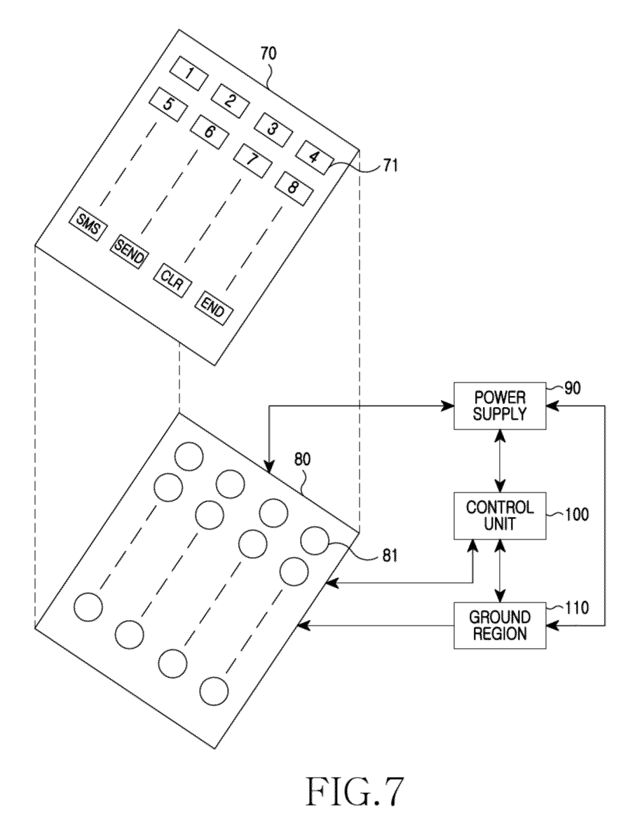

FIG. 7 illustrates an apparatus including a keypad connection unit according to an exemplary embodiment of the present invention.

Referring to FIG. 7, an apparatus for a keypad of a portable terminal includes a top unit 70, a bottom unit 80, a power supply 90, a control unit 100 and a ground region 110.

The top unit 70 includes keys 71 having numerals, characters, symbols, and the like printed thereon. The keys 71 allow for input control of the apparatus by a user. The bottom unit 80 includes a plurality of keypad connection units 81 formed thereon, wherein each of the keypad connection units 81 includes a divided connection unit and a common connection unit as described above with reference to FIGS. 3A and 6. In an exemplary implementation, the bottom unit 80 is made from a PCB including the keypad connection units and associated wiring formed thereon. Each of the keypad connection units 81 is associated with a key 71 formed on the top unit 70 so that, when a user presses a key 71, an associated keypad connection unit 81 connects the divided connection unit to the common connection unit. The power supply unit 90 supplies a voltage to the common connection unit of each keypad connection unit 81. Thus, when the common connection unit contacts the divided connection unit, a voltage is applied from the common connection unit to the divided connection unit. The control unit 100 receives the voltage from the divided connection units. More specifically, the control unit 100 includes a number of I/O ports that are electrically connected to specific ones of the divided connection units of each keypad connection unit 81. Through the selective electrical connections, the I/O ports receive the voltage from the corresponding divided connection unit. The apparatus further includes a ground region 110 which is connected to a ground side of the power supply 90 and a ground side of the control unit 100. The ground region 110 provides a connection point for the voltage from the power supply 90, provided through the divided connection units of the keypad connection unit 81 to the control unit 100, to return and thus provide a complete electrical circuit.

In the illustrated example of FIG. 7, the bottom unit 80 is shown including only the keypad connection units 81 and separate from the power supply 90, the control unit 100 and the ground region 110. However, in an exemplary implementation, each of the power supply 90, the control unit 100 and the ground region 110 may also be provided on the bottom unit 80. Although not illustrated, the apparatus may further include a memory unit for storing various programs and temporary data of the apparatus as well as a mapping table by which the control unit 100 determines which key value is associated with a received input signal.

As described above, exemplary embodiments of the present invention can reduce the number of I/O ports by dividing a keypad connection unit into several connection subunits and coding the same. Exemplary embodiments of the present invention reduce the number of I/O ports or use free I/O ports for different functions, thus making it possible to reduce the weight and size of a portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for a keypad of a portable terminal, the apparatus comprising:
a top unit including a key;
a bottom unit including a keypad connection unit corresponding to the key, the keypad connection unit having a divided connection unit, comprised of a plurality of connection subunits, and a common connection unit that are connected when the key is pressed; and
a control unit connected to the keypad connection unit to receive a signal generated according to the press of the key and to perform a corresponding function.

2. The apparatus of claim 1, wherein the control unit is connected to at least one of the connection subunits of the divided connection unit.

3. The apparatus of claim 2, further comprising a power supply unit electrically connected to the common connection unit to supply a voltage thereto.

4. The apparatus of claim 3, wherein, according to the press of the key, the voltage supplied to the common connection unit is supplied to the plurality of connection subunits, and further wherein the control unit detects the connection of the at least one connection subunit as “1” and detects a non-connected subunit as “0”.

5. The apparatus of claim 1, wherein the top unit includes (2ⁿ−1) keys, and the bottom unit includes (2ⁿ−1) keypad connection units corresponding to the keys, wherein n corresponds to the number of connection subunits of each of the divided connection units of the keypad connection units.

6. The apparatus of claim 5, wherein each of the divided connection units is divided into five connection subunits and the top unit includes 31 keys.

7. The apparatus of claim 5, wherein each of the divided connection units is divided into six connection subunits and the top unit includes 63 keys.

8. The apparatus of claim 1, wherein the signal generated according to the press of the key is received and mapped to a preset key value to at least one of display a corresponding key value and perform a specific function assigned to the corresponding key value.

9. A method for using a keypad of a portable terminal, the method comprising:
pressing a key on the keypad;
generating a signal from a keypad connection unit corresponding to the key, the keypad connection unit having a common connection unit and a divided connection unit, comprised of a plurality of connection subunits, according to the press of the key;
mapping the generated signal to a preset key value; and
performing a function corresponding to a key mapped to the preset key value.

10. The method of claim 9, wherein at least one of the connection subunits of the divided connection unit are connected to a control unit.

11. The method of claim 10, further comprising supplying a power supply voltage to the common connection unit.

12. The method of claim 11, wherein, according to the press of the key, the voltage supplied to the common connection unit is supplied to the plurality of connection subunits, and further wherein the control unit detects the connection of the at least one connection subunit as “1” and detects a non-connected port detected as “0”.

13. The method of claim 9, wherein the signal generated according to the press of the key is received and mapped to a preset key value to at least one of display a corresponding key value and perform a specific function assigned to the corresponding key value.

14. A key input apparatus, the apparatus comprising:
a divided connection unit including a plurality of connection subunits; and
a common connection unit,
wherein the divided connection unit is connected to the common connection unit upon operation of the key input apparatus.

15. The apparatus of claim 14, wherein the plurality of connection subunits are located at a perimeter surrounding the common connection unit.

16. The apparatus of claim 14, wherein the common connection unit is configured as a ring and the plurality of connection subunits are located internal to the ring.
